(19) United States
(12) Patent Application Publication
(10) Pub. No.: US 2008/0238812 A1
(43) Pub. Date: Oct. 2, 2008

(54) MULTI-SCREEN DISPLAY SYSTEM AND METHOD OF SETTING MULTI-SCREEN DISPLAY

(76) Inventors: Zhijun Xiang, Beijing (CN); Shigui He, Beijing (CN)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/057,800

(22) Filed: Mar. 28, 2008

(30) Foreign Application Priority Data
Mar. 30, 2007 (CN) 200710065033.4

(51) Int. Cl. G09G 5/00

(52) U.S. Cl. 345/1.1

(57) ABSTRACT

The invention provides a multi-screen display system and a method of setting a multi-screen display. The multi-screen display system comprises a computer mainframe and a plurality of displays. The computer mainframe is provided with an obtaining module for obtaining a moving track of a mouse; a monitoring module for monitoring the obtained moving track, and triggering an adjustment module when it is monitored that the mouse fails to go across a display border or the display to which the mouse enters is not in accordance with a display as desired; and the adjustment module for adjusting the multi-screen display setting according to the triggering to the monitoring module so that the display to which the mouse enters is in accordance with the display as desired. A solution of the present invention performs the multi-screen display setting automatically according to the moving track of the mouse. During the multi-screen display setting process, it is not necessary to remember serial numbers and relative positions of the respective displays, which is simple to operate; and no new hardware overhead will be added, which is cost-effective.

### RELATED APPLICATION

The present application claims priority to CN Application No. 200710065033.4 filed Mar. 30, 2007, which is incorporated herein in its entirety by reference.

### BACKGROUND OF THE INVENTION

1. Field of the Invention

The present invention relates to a field of a computer, particularly to a multi-screen display system and a method of setting a multi-screen display.

2. Description of Prior Art

With the increasing working requirement, the current sizes of displays in the mainstream gradually could not meet the requirement. In terms of processing capability and usage requirement of current personal computers (PCs), it is very common to run Internet Explorer® (IE) to browse web pages, open WORD® to process a document and even open Photoshop® to process images simultaneously. Display areas of the current displays in the mainstream, however, are difficult to ensure such multi-task operations, thereby the processing capability of a PC is not a bottleneck anymore, but the real bottleneck appears in the displaying part.

To solve the problem that the size of the display cannot meet the requirement of a user, a multi-screen display scheme may be provided. A multi-screen display means that different output contents are displayed simultaneously on a main display and an external display (or a projector); a plurality of displays may adjust a refresh rate, a resolution and a color depth of the display, and may support various applications. The multi-screen display scheme can spread a desktop space of a user. However, there exists a problem in that it is troublesome to set a multi-screen display. In order to avoid a malposition and perform a relatively natural operation, a user may generally make an associated setting according to the actual positions of the displays. When the actual positions of a plurality of displays are changed frequently, the setting has to be changed correspondingly frequently, which brings trouble and bother to users. Taking two displays as an example, when a main display is located on the right and a solve display is located on the left, the user makes an associated setting according to the actual situation; if the main display is placed on the left and the slave display is placed on the right at a later time, the user has to change the setting because the user would be very unaccustomed to using a mouse and moving a window between these two displays if the setting is not based on the actual positions; also when the multi-screen display setting is performed, serial numbers and relative positions of various displays are required to be remembered; and when the number of displays is larger, it is very difficult to make such a setting.

Due to this, a solution in the prior art is: setting on a display a position sensor for identifying relative positions among a plurality of displays; then transmitting such relative positions to a computer system; setting a multi-screen display automatically by the computer system according to the obtained relative positions. However, this solution needs hardware overhead and is costly.

### SUMMARY OF THE INVENTION

Accordingly, a main object of the present invention is to provide a multi-screen display system and a method of setting a multi-screen display, capable of implementing an automatic setting of a multi-screen display with a simple operation and a lower cost.

To solve the above problems, schemes are provided in the present invention as follows:

A method of setting a multi-screen display for a system comprising a mainframe and a plurality of displays, wherein a multi-screen display setting is performed according to a moving track of a mouse.

In one embodiment, the method of setting a multi-screen display comprises the steps of obtaining the moving track of the mouse; determining whether the mouse fails to go across a display border or whether the display to which the mouse enters is not in accordance with a display as desired according to the obtained moving track of the mouse; and adjusting the multi-screen display setting when it is determined that the mouse fails to go across the display border or the display to which the mouse enters is not in accordance with a display as desired, so that the display to which the mouse enters is in accordance with the display as desired.

In one embodiment, when it is determined that the mouse fails to go across the display border or the display to which the mouse enters is not in accordance with a display as desired, and when a predefined hot key or a left-key of the mouse is pressed, the multi-screen display setting is adjusted again.

In one embodiment, the adjustment of the multi-screen display setting comprises the steps of considering a display the border of which the mouse has gone across the border as a reference display and taking a moving direction of the mouse as a reference direction, in order to select other displays sequentially to try to perform the setting, which comprises in detail: setting the selected display to a position adjacent to the reference display in the reference direction of the reference display; and completing the current adjustment when the display to which the mouse enters is in accordance with a display as desired.

In one embodiment, when the current adjustment is completed, a successfully adjusted display is recorded; and when the subsequent adjustment is performed, the successfully adjusted display is not selected to try to perform the setting.

In one embodiment, when all of the displays have been adjusted successfully, the multi-screen display setting is completed.

A multi-screen display system comprising a computer mainframe and a plurality of displays, wherein the computer mainframe is provided with:

an obtaining module for obtaining a moving track of a mouse;

a monitoring module for monitoring the obtained moving track, and triggering an adjustment module when it is monitored that the mouse fails to go across a display border or the display to which the mouse enters is not in accordance with a display as desired; and

the adjustment module for adjusting the multi-screen display setting according to the triggering to the monitoring module, so that the display to which the mouse enters is in accordance with the display as desired.

Herein, the monitoring module is further used for monitoring whether there is a predefined hot key or a left-key of the mouse being pressed, and for triggering the adjustment module when it is monitored that the mouse fails to go across the display border or the display to which the mouse enters is not in accordance with a display as desired and when the predefined hot key or the left-key of the mouse is pressed.

A solution of the present invention performs the multi-screen display setting automatically according to the moving track of the mouse. During the multi-screen display setting process, it is not necessary to remember serial numbers and relative positions of the respective displays, which is simple to operate; and no new hardware overhead will be added, which is cost-effective.

### BRIEF DESCRIPTION OF THE DRAWINGS

FIG. 1 is an illustrative structural diagram of a computer mainframe of a multi-screen display system according to an embodiment of the present invention; and

FIGS. 2-11 are schematic views of making a multi-screen display setting to a multi-screen display system comprising 2×2 displays according to the present invention.

### DETAILED DESCRIPTION OF THE PREFERRED EMBODIMENTS

Hereinafter, the present invention will be further described in detail by referring to the drawings and the embodiments in order to make the objects, technical scheme and advantages of the present invention more apparent.

In a multi-screen display system, for example, in a case of a dual-screen display, an actual position of the displays may change, e.g., a slave display may move from the left of a main display to the right of the main display. If a mouse or its cursor is currently located in the main display but a user needs to operate on the slave display, the mouse is naturally moved to the right for the purpose of going across the right border of the main display transversely to move to the slave display. However, since the actual display position in the system is that the slave display is located on the left of the main display, it is useless to move to the right anyway, i.e., the mouse fails to go across the border. In addition, in a case of more than two displays, it is possible that the mouse goes to a display other than the one as desired. Therefore, when the mouse fails to go across the display border or goes to the display other than the one as desired, it is necessary to adjust the multi-screen display setting.

The principal idea of the present invention is to set a multi-screen display according to a moving track of a mouse. By monitoring the moving track of the mouse, a real operational intention of the user and further, a relative position relationship between displays may be obtained, e.g., the mouse moving right to try to go across the border of the main display means that the slave display is located on the right of the main display, thereby a system program is informed to change the multi-screen setting so as to set the slave display to the right of the main display.

A detailed process of the multi-display setting method according to an embodiment of the present invention comprises the steps of obtaining the moving track of the mouse; determining whether the mouse fails to go across the border of the display or whether the display to which the mouse enters is not in accordance with a display as desired according to the obtained moving track of the mouse; and adjusting the multi-screen display setting when it is determined that the mouse fails to go across the display border or the display to which the mouse enters is not in accordance with a display as desired, so that the display to which the mouse enters is in accordance with the display as desired.

Wherein, the mouse failed to go across the display border means that when the mouse or its cursor moves to the display border, it tries to move outside, but the moving is failed. Such an action may be known by the system program. A human-computer interaction interface may be set up. When the mouse goes across the display border, the user determines whether the display to which the mouse enters is in accordance with the display as desired through the human-computer interaction interface such as a window popped up in the display screen.

In an embodiment of the present invention, the detailed method of adjusting the multi-screen display setting is: considering a display of which before the mouse goes across the border as a reference display and taking a moving direction of the mouse as a reference direction, in order to select other displays sequentially to attempt to perform the setting. Such an attempt means setting the selected display to a position adjacent to the reference display in the reference direction of the reference display; when the display to which the mouse enters is not in accordance with the display as desired, a next display is selected to perform the same operation, until the display to which the mouse enters is in accordance with the display as desired and the current adjustment is completed.

To save the processing time and the processing steps, when the current adjustment has been completed (which means that one display has been set successfully), the display which has been adjusted successfully is also recorded. When a subsequent adjustment is performed, the successfully adjusted display is not selected to try to perform the setting.

When the mouse moves from the reference display in another direction, the setting is performed in the same approach as described above, until all of the displays have been set, and then the process of multi-screen display setting is ended.

In some situations, it is possible to make a maloperation according to the method of setting the multi-screen display of the above embodiments. That is to say, when an adjustment is not expected, the system performs the adjustment automatically. For example, the mouse attempts to go across the display border, but there is no display in the moving direction of the mouse. In order to avoid unnecessary adjustments, in one embodiment of the present invention, it is possible to restrict a triggering condition of the multi-screen display setting adjustment, i.e., when it is determined that the mouse fails to go across the display border or the display to which the mouse enters is not in accordance with a display as desired, and when a predefined hot key or a left-key of the mouse is pressed, the multi-screen display setting is adjusted.

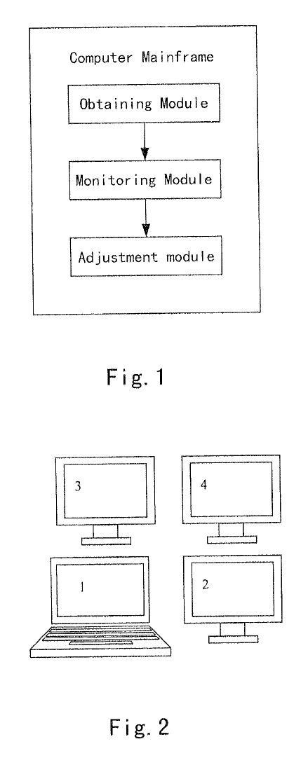

Referring to FIG. 1, a multi-screen display system according to the present invention comprises a computer mainframe and a plurality of displays. The computer mainframe is provided with an obtaining module, a monitoring module and an adjustment module.

The obtaining module obtains a moving track of a mouse; the monitoring module monitors the obtained moving track, and triggers an adjustment module when it is monitored that the mouse fails to go across a display border or the display to which the mouse enters is not in accordance with a display as desired; and the adjustment module adjusts the multi-screen display setting according to the triggering to the monitoring module, so that the display to which the mouse enters is in accordance with the display as desired.

In another embodiment of the present invention, the monitoring module is further used for monitoring whether there is a predefined hot key or a left-key of the mouse being pressed, and for triggering the adjustment module when it is monitored that the mouse fails to go across the display border or the display to which the mouse enters is not in accordance with a display as desired and when the predefined hot key or the left-key of the mouse is pressed.

An illustrative embodiment according to the present invention in which a multi-screen display setting is performed to a multi-screen display system comprising 2×2 displays is explained below.

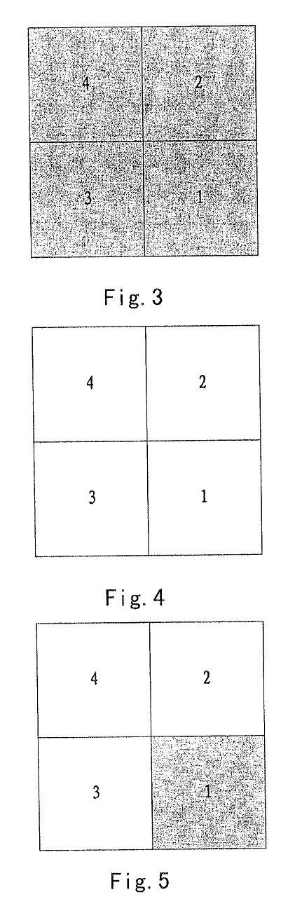

The actual locations of four displays are shown in FIG. 2, wherein No. 1 display is a main display (i.e. a reference display), and there is one extended display on the right, upside and right-upside of the main display respectively. Assuming that a display setting condition of a current system is shown in FIG. 3 (in FIGS. 3 to 11, displays denoted with shadowing are displays adjusted successfully and otherwise are displays not adjusted successfully), the extended displays are located on the left, upside and left-upside of the main display. Obviously, such a display setting is not in accordance with the actual positions of displays.

When the system has detected all of the displays connected, the display setting state is firstly cleared (as referred to FIG. 4). In the illustrative embodiment, the main display is considered as the reference display. All the adjustment of setting is adjusted according to the main display, so firstly the No. 1 display is recorded as a display of successful adjustment (as referred to in FIG. 5).

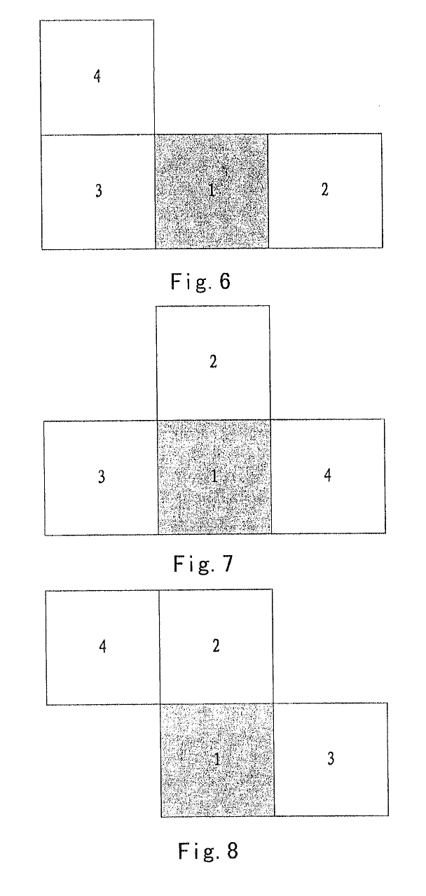

Referring to FIGS. 2 and 3, when the user wants to operate on No. 2 display, he moves the mouse to the right of the No. 1 display and attempts to go across the display border. At this time, since the actual display setting is that there is no display on the right of the main display, the mouse cannot be moved across, i.e. the mouse fails to go across the border. Then, when the triggering condition is met, the system adjusts the multi-screen display setting automatically. Here, there are three setting approaches to be selected as shown in FIGS. 6 to 8, respectively.

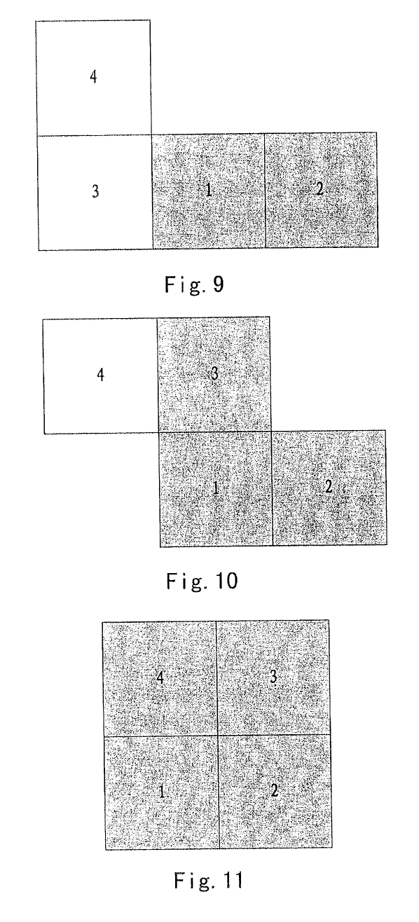

The multi-screen display is set by the system sequentially per the above three states. One human-computer interaction interface is provided for each setting state, so that the user may determine whether the display to which the mouse enters is in accordance with the display as desired. When the user considers the current setting is not the setting as required, i.e., the setting as shown in FIG. 7 or 8, the user selects NO in the human-computer interaction interface. The system will continue the adjustment with the remaining two settings, until the user determines that the current setting is the setting as required (the setting as shown in FIG. 6), then, the user selects YES in the human-computer interaction interface and records the No. 2 display as a display of successful adjustment. At this time, the display setting state is as shown in FIG. 9.

Subsequently, if the user wants to operate on No. 3 display, he moves the mouse to the upside of the No. 1 display. Since the display setting is not correct, it could not be moved thereto. The adjusted setting is as shown in FIG. 10 in the same principle.

Finally, the user moves the mouse to the right-upside of the No. 1 display and attempts to operate on No. 4 display. In the same way, the adjustment of the multi-screen display setting is also triggered and the adjusted setting is as shown in FIG. 11. At this time, the setting condition of multi-screen display is in accordance with the actual positions of displays, and all the displays have been adjusted successfully. The system then closes the function of automatic setting. The next time the states of displays connected to the system are detected to be changed, the system opens this function again, thereby avoiding a frequent occurrence of the human-computer interaction interface.

The above represents only the preferred embodiments of the present invention, and the present invention is not limited to the above embodiments. Therefore, any modifications, substitutions and improvements to the present invention are possible without departing from the spirit and scope of the present invention.

1. A method of setting a multi-screen display for a system comprising a computer mainframe and a plurality of displays, wherein the multi-screen display setting is performed according to a moving track of a mouse.

2. The method of setting a multi-screen display according to claim 1, which comprises the steps of:
obtaining the moving track of the mouse;
determining whether the mouse fails to go across a display border or whether the display to which the mouse enters is not in accordance with a display as desired according to the obtained moving track of the mouse; and
adjusting the multi-screen display setting when it is determined that the mouse fails to go across the display border or the display to which the mouse enters is not in accordance with a display as desired, so that the display to which the mouse enters is in accordance with the display as desired.

3. The method of setting a multi-screen display according to the claim 2, wherein the step of adjusting the multi-screen display setting is performed when it is determined that the mouse fails to go across the display border or the display to which the mouse enters is not in accordance with a display as desired, and when a predefined hot key or a left-key of the mouse is pressed.

4. The method of setting a multi-screen display according to claim 2, wherein the step of adjusting the multi-screen display setting comprises the steps of:
considering a display the border of which the mouse has gone across as a reference display and taking a moving direction of the mouse as a reference direction, in order to select other displays sequentially to try to perform the setting, which comprises:
setting the selected display to a position adjacent to the reference display in the reference direction of the reference display; and
completing the current adjustment when the display to which the mouse enters is in accordance with a display as desired.

5. The method of setting a multi-screen display according to claim 4, further comprising the steps of:
recording a successfully adjusted display when the current adjustment is completed; and
not selecting the successfully adjusted display to try to perform the setting when the subsequent adjustment is performed.

6. The method of setting a multi-screen display according to claim 5, further comprising:
completing the multi-screen display setting when all of the displays have been adjusted successfully.

7. A multi-screen display system comprising a computer mainframe and a plurality of displays, wherein the computer mainframe comprises:
an obtaining module for obtaining a moving track of a mouse;
a monitoring module for monitoring the obtained moving track, and triggering an adjustment module when it is monitored that the mouse fails to go across a display border or the display to which the mouse enters is not in accordance with a display as desired; and
an adjustment module for adjusting the multi-screen display setting according to the triggering to the monitoring module, so that the display to which the mouse enters is in accordance with the display as desired.

8. The multi-screen display system according to claim 7, wherein the monitoring module is further used for monitoring whether there is a predefined hot key or a left-key of the mouse being pressed, and for triggering the adjustment module when it is monitored that the mouse fails to go across the display border or the display to which the mouse enters is not in accordance with a display as desired and when the predefined hot key or the left-key of the mouse is pressed.
